(19) United States
(12) Patent Application Publication
(10) Pub. No.: US 2013/0233584 A1
(43) Pub. Date: Sep. 12, 2013

(54) Power Tool and Power Tool System

(71) Applicant: HITACHI KOKI CO., LTD., Tokyo (JP)

(72) Inventor: Hironori Mashiko, Hitachinaka (JP)

(73) Assignee: HITACHI KOKI CO., LTD., Tokyo (JP)

(21) Appl. No.: 13/752,207

(22) Filed: Jan. 28, 2013

(30) Foreign Application Priority Data
Mar. 9, 2012 (JP) 2012-052457

(51) Int. Cl. B25B 23/147; B25B 21/00; B25F 5/00

(52) U.S. Cl. CPC B25B 23/147; B25F 5/001; B25B 21/00
USPC 173/181; 173/47; 173/20

(57) ABSTRACT

A power tool includes a bit mounting unit, a motor, and a control unit. The bit mounting unit is configured to mount thereon a bit. The motor is configured to rotatingly drive the bit. The control unit is configured to control a drive of the motor. The control unit includes a storing unit configured to store a plurality of prescribed values affecting the drive of the motor and a division number by which a range of the plurality of prescribed values is divided. At least one of the range and the division number is arbitrarily settable.

### CROSS REFERENCE TO RELATED APPLICATION

This application claims priorities from Japanese Patent Application No. 2012-052457 filed Mar. 9, 2012. The entire content of this priority application is incorporated herein by reference.

### TECHNICAL FIELD

The invention relates to a power tool and a power tool system, and particularly to a power tool system capable of changing an operation mode of a power tool.

### BACKGROUND

In a screw driving tool or the like that is used at an assembly site such as an automobile plant, specific setting of tightening torque is required, and adjustments of torque setting are required for each tightened part. Thus, a tool capable of setting driving torque as disclosed in Japanese Patent Application Publication No. 2011-31314 is used to set predetermined tightening torque suitable for a tightened part, so that a driving operation is performed.

### SUMMARY

In the above-described tool, a maximum value, a minimum value, and settable values between the maximum value and the minimum value of tightening torque are set preliminarily. Hence, when an operation requires tightening torque outside this preset range, a tool needs to be provided for each required tightening torque. In view of the foregoing, it is an object of the invention to provide a power tool capable of dealing with a wide range of tightening torque with a single power tool, and to provide a power tool system capable of setting a wide range of tightening torque.

In order to attain the above and other objects, the present invention provides a power tool. The power tool includes a bit mounting unit, a motor, and a control unit. The bit mounting unit is configured to mount thereon a bit. The motor is configured to rotatingly drive the bit. The control unit is configured to control a drive of the motor. The control unit includes a storing unit configured to store a plurality of prescribed values affecting the drive of the motor and a division number by which a range of the plurality of prescribed values is divided. At least one of the range and the division number is arbitrarily settable.

With this configuration, because a range of prescribed values affecting operations of a motor or a division number can be set arbitrarily, a wide range of operations can be performed with a single power tool. Further, because prescribed values affecting operations of the motor can be changed on the power tool itself, changes of the prescribed values or the like become easier.

According to another aspect of the invention, the present invention provides a power tool. The power tool includes a bit mounting unit, a motor, a control unit, a selecting unit, and an external device connecting unit. The bit mounting unit is configured to mount thereon a bit. The motor is configured to rotatingly drive the bit mounting unit. The control unit is configured to control a drive of the motor. The control unit includes a storing unit and a torque determining unit. The torque determining unit is configured to determine the fastening torque. The storing unit is configured to store a plurality of prescribed values having a range for determining a fastening torque and a division number by which the range is divided. The selecting unit is configured to select one of the plurality of prescribed values. The torque determining unit determines the fastening torque based on the selection of the selecting unit. The external device connecting unit is configured to be connected to an external device. The external device includes a changing unit configured to change at least one of the range of the plurality of prescribed values and the division number.

With this configuration, because a division number and a plurality of prescribed values can be changed, a wide range of tightening torque can be obtained with a single power tool. Further, because an external device is required to change the reference value and the like, inadvertent changes of the division number and the like can be suppressed.

According to still another aspect of the invention, the present invention provides a power tool. The power tool includes a bit mounting unit, a motor, a control unit, and a selecting unit. The bit mounting unit is configured to mount thereon a bit. The motor is configured to rotatingly drive the bit mounting unit. The control unit is configured to control a drive of the motor. The control unit includes a storing unit and a torque determining unit . The torque determining unit is configured to determine a fastening torque. The storing unit is configured to store a plurality of prescribed values having a range for determining the fastening torque and a division number by which the range is divided. The selecting unit is configured to select one of a first operation mode and a second operation mode. The selecting unit selects one of the plurality of prescribed values in the first operation mode and the torque determining unit determines the fastening torque based on the selection of the selecting unit. The selecting unit changes at least one of the range of plurality of prescribed values and the division number in the second operation mode.

With this configuration, too, because a division number and a plurality of prescribed values can be changed, a wide range of tightening torque can be obtained with a single power tool. Further, because the division number and the like can be changed on the power tool itself, changes of the reference value and the like become easier.

According to further aspect of the invention, the present invention provides a power tool system. The power tool system includes a power tool and an external device. The power tool includes a bit mounting unit, a motor, a control unit, a selecting unit, and an external device connecting unit. The bit mounting unit is configured to mount thereon a bit. The motor is configured to rotatingly drive the bit mounting unit. The control unit is configured to control a drive of the motor. The control unit includes a storing unit and a torque determining unit. The torque determining unit is configured to determine a fastening torque. The storing unit is configured to store a plurality of prescribed values having a range for determining the fastening torque and a division number by which the range is divided. The selecting unit is configured to select one of the plurality of prescribed values. The torque determining unit determines the fastening torque based on the selection of the selecting unit. The external device is configured to connect to the external device connecting unit. The external device includes a changing unit configured to change at least one of the range of the plurality of prescribed values and the division number.

### BRIEF DESCRIPTION OF THE DRAWINGS

The particular features and advantages of the invention as well as other objects will become apparent from the following description taken in connection with the accompanying drawings, in which:

FIG. 1 is a central cross-sectional view of an electronic pulse driver according to a first embodiment of the present invention;

FIG. 2 is a block diagram of the electronic pulse driver according to the first embodiment of the present invention;

FIG. 3A is a schematic view showing a display section of the electronic pulse driver according to the first embodiment of the present invention;

FIG. 3B is an explanation view showing a transition of a display of the display section each time a switch 26 is pressed according to the first embodiment of the present invention;

FIG. 4 is a schematic view showing a state where the electronic pulse driver is connected to a PC according to the first embodiment of the present invention;

FIG. 5 is a flowchart explaining a process for determining setting values in the electronic pulse driver according to the first embodiment of the present invention;

FIG. 6 is a window of the PC before the PC is connected to the electronic pulse driver according to the first embodiment of the present invention;

FIG. 7 is a window of the PC after the PC is connected to the electronic pulse driver according to the first embodiment of the present invention;

FIG. 8 is a window of the PC when an error message is displayed on the PC according to the first embodiment of the present invention;

FIG. 9 is a window of the PC when an error message is displayed on the PC according to the first embodiment of the present invention;

FIG. 10 is a window of the PC when the PC reads in the setting values therein according to the first embodiment of the present invention;

FIG. 11 is a window of the PC when the setting of the setting values is completed in the PC according to the first embodiment of the present invention;

FIG. 12 is a block diagram of an electronic pulse driver according to a second embodiment of the present invention;

FIG. 13 is a flowchart explaining a process for determining setting values in the electronic pulse driver according to the second embodiment of the present invention;

FIG. 14 is a schematic view showing a display section of the electronic pulse driver according to the second embodiment of the present invention;

FIG. 15 is a schematic view showing the display section of the electronic pulse driver when a setting of the minimum value is started according to the second embodiment of the present invention;

FIG. 16 is a schematic view showing the display section of the electronic pulse driver when the setting of the minimum value is completed according to the second embodiment of the present invention;

FIG. 17 is a schematic view showing the display section of the electronic pulse driver when a setting of a maximum value is started according to the second embodiment of the present invention;

FIG. 18 is a schematic view showing the display section of the electronic pulse driver when the setting of the maximum value is completed according to the second embodiment of the present invention;

FIG. 19 is a schematic view showing the display section of the electronic pulse driver when a setting of the number of steps is started according to the second embodiment of the present invention;

FIG. 20 is a schematic view showing the display section of the electronic pulse driver when a setting of the number of steps is completed according to the second embodiment of the present invention; and

FIG. 21 is a schematic view showing the display section of the electronic pulse driver when reviewing the setting values according to the second embodiment of the present invention.

### DETAILED DESCRIPTION

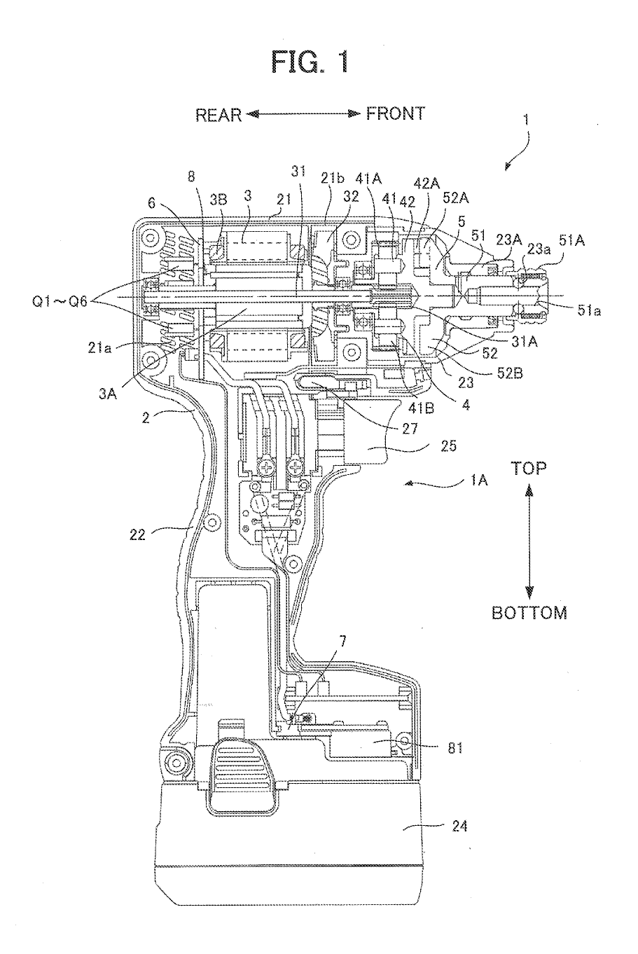

Hereinafter, an electronic pulse driver 1 as an example of a power tool according to a first embodiment of the invention and a configuration combined with a PC (personal computer) 10 as an example of an external device will be described while referring to FIGS. 1 through 11. The PC 10 changes tightening torque characteristics as an operation mode of the electronic pulse driver 1 (an operation-mode change system of the power tool).

As shown in FIG. 1, the electronic pulse driver 1 includes a main body 1A and a battery 24. The main body 1A mainly includes a housing 2, a motor 3, a hammer section 4, an anvil section 5, an inverter circuit board 6, a control section 7, and rotational-position detecting elements (Hall elements) 8. The housing 2 is made of resin and constitutes an outer shell of the electronic pulse driver 1. The housing 2 mainly includes a body section 21 having substantially a cylindrical shape and a handle section 22 extending from the body section 21.

The motor 3 is disposed within the body section 21 such that the longitudinal direction of the body section 21 matches the axial direction of the motor 3. Also, within the body section 21, the hammer section 4 and the anvil section 5 are arranged toward one end side in the axial direction of the motor 3. In the following descriptions, the anvil section 5 side is defined as a front side, the motor 3 side is defined as a rear side, and a direction parallel to the axial direction of the motor 3 is defined as a front-rear direction. Additionally, the body section 21 side is defined as a top side, the handle section 22 side is defined as a bottom side, and a direction in which the handle section 22 extends from the body section 21 is defined as a top-bottom direction. Further, a direction perpendicular to the front-rear direction and to the top-bottom direction is defined as a left-right direction.

The body section 21 has a front portion provided with a metal-made hammer case 23 in which the hammer section 4 and the anvil section 5 are provided. The hammer case 23 has substantially a funnel shape tapering toward the front side. The hammer case 23 has a front-end portion formed with an opening 23a. A metal 23A is provided at an inner surface defining the opening 23a.

The body section 21 is formed with a plurality of inlet ports 21a and outlet ports 21b for introducing external air into the body section 21 and for discharging air to the outside, respectively, with a fan 32 described later. The motor 3 is cooled by the external air.

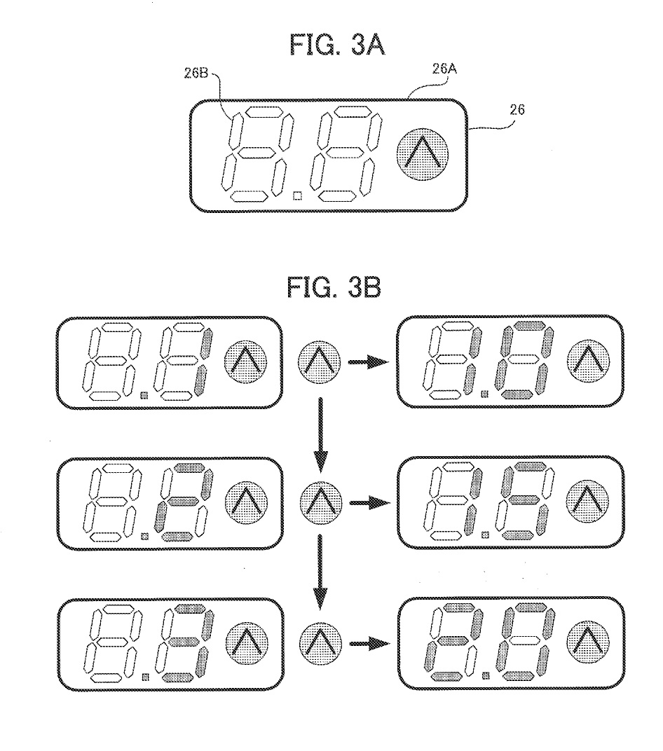

The handle section 22 extends downward from approximately a center position of the body section 21 in the front-rear direction, and is formed integrally with the body section 21. The battery 24 for supplying the motor 3 and the like with electric power is detachably mounted on the bottom end of the handle section 22. The handle section 22 includes a trigger 25, a switching lever 27, a switch 26 (FIG. 3A), and a display section 26A (FIG. 3A). The trigger 25 is provided at a front upper portion of the handle section 22. The switching lever 27 for alternately selecting a rotational direction of the motor 3 is provided immediately above the trigger 25. The switch 26 shown in FIG. 3A for determining a tightening torque described later is provided on a lower right-side surface of the handle section 22. The switch 26 is disposed within the display section 26A and is for selecting one of the plurality of prescribed values defined between a maximum value and a minimum value, in order to determine the tightening torque. Specifically, the switch 26 is so configured that the prescribed value increases by one step when the switch 26 is pressed once for a short time (“press short”: to keep for 500 msec or less a state where the switch 26 is being pressed) and that the prescribed value returns to the minimum value when the switch 26 is further pressed short after the prescribed value reaches the maximum value. The switch 26 serves as a selecting unit of the present invention. The display section 26A includes two-sets of seven-segment display section 26B that displays the prescribed value. The display section 26A serves as a display unit of the present invention.

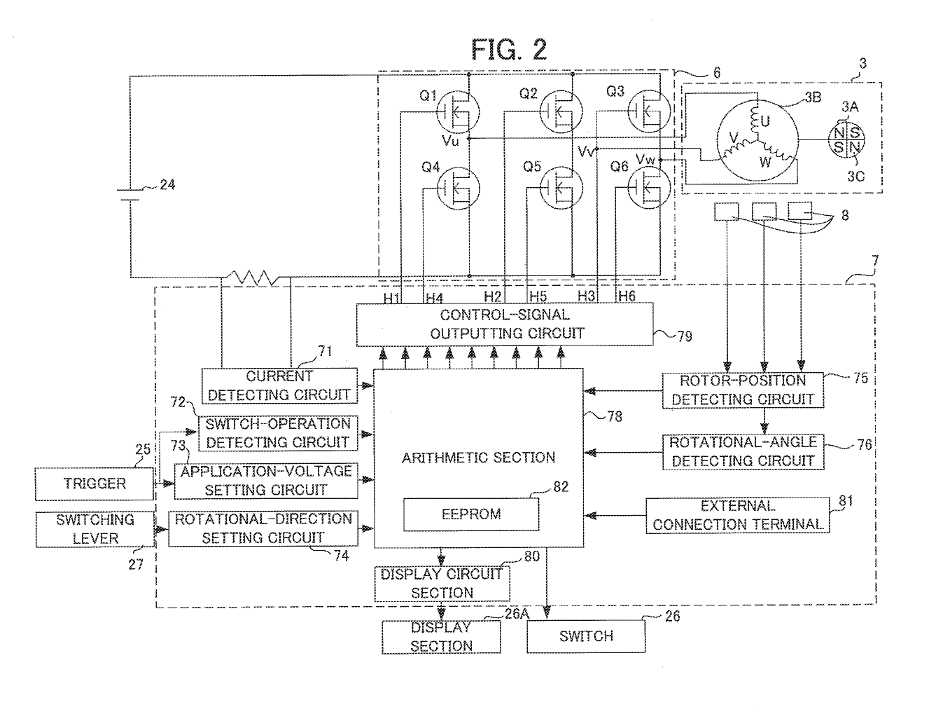

The motor 3 is a brushless motor mainly including a rotor 3A having an output shaft section 31 and a stator 3B arranged in confrontation with the rotor 3A. The rotor 3A is provided with a permanent magnet 3C (FIG. 2). The motor 3 is disposed within the body section 21 such that the axial direction of the output shaft section 31 is coincident with the front-rear direction. The output shaft section 31 protrudes forward and rearward from the rotor 3A, and is rotatably supported at the protruding portions by the body section 21 via bearings. The fan 32 rotatable coaxially and together with the output shaft section 31 is provided at the front protruding section of the output shaft section 31. Further, a pinion gear 31A rotatable coaxially and together with the output shaft section 31 is provided at the front-end position of the front protruding section of the output shaft section 31.

The hammer section 4 mainly includes a gear mechanism 41 and a hammer 42, and is disposed at the front side of the motor 3 within the hammer case 23. The gear mechanism 41 includes a planetary gear mechanism 41B having an outer gear 41A. The outer gear 41A is disposed within the hammer case 23 and is fixed to the body section 21. The planetary gear mechanism 41B is disposed within the outer gear 41A so as to meshingly engage the outer gear 41A.

The hammer 42 is defined at the front side of a planetary carrier of the planetary gear mechanism 41B. The hammer 42 includes a first engaging protrusion 42A that protrudes forward and that is disposed at a position shifted from a rotational center of the planetary carrier of the planetary gear mechanism 41B, and a second engaging protrusion (not shown) that is located at a directly opposite position to the first engaging protrusion 42A with respect to the rotational center of the planetary carrier of the planetary gear mechanism 41B.

The anvil section 5 is disposed at the front side of the hammer section 4, and mainly includes an end-bit mounting section 51 and an anvil 52. The end-bit mounting section 51 has a cylindrical shape, and is rotatably supported in opening 23a of the hammer case 23 via the metal 23A. The end-bit mounting section 51 is formed with a bore 51a in the front-rear direction through which a bit (not shown) is detachably inserted. The end-bit mounting section 51 has a front end portion provided with a chuck 51A for holding a bit (not shown). The end-bit mounting section 51 serves as a bit mounting unit of the present invention.

The anvil 52 is provided integrally with the end-bit mounting section 51 at a position rearward of the end-bit mounting section 51 and within the hammer case 23. The anvil 52 includes a first engaged protrusion 52A and a second engaged protrusion 52B that protrude rearward and that are located at directly opposite positions with respect to the rotational center of the end-bit mounting section 51. When the hammer 42 rotates, the first engaging protrusion 42A and the first engaged protrusion 52A collide with each other and, at the same time, the second engaging protrusion (not shown) and the second engaged protrusion 52B collide with each other, which causes rotational force of the hammer 42 to be transmitted to the anvil 52.

As shown in FIG. 2, the inverter circuit board 6 includes six (6) switching elements Q1-Q6 such as FETs that are connected in three-phase bridge connection. The switching elements Q1-Q6 are attached to the inverter circuit board 6. The inverter circuit board 6 is fixed to the motor 3 at the rear end of the motor 3 such that the inverter circuit board 6 is substantially perpendicular to the output shaft section 31. Note that, as shown in FIG. 1, the switching elements Q1-Q6 are attached to the inverter circuit board 6 such that the longitudinal direction of the switching elements Q1-Q6 is substantially parallel to the output shaft section 31. The plurality of inlet ports 21a is formed in the body section 21 at positions radially outwardly from the inverter circuit board 6. On the other hand, the outlet port 21b is formed in the body section 21 at a position radially outwardly from the fan 32.

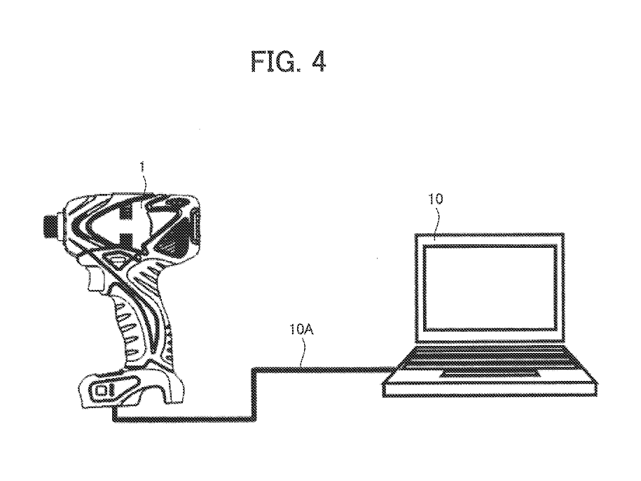

The control section 7 is mounted on a board that is disposed at a position adjacent to the battery 24 in the handle section 22. The control section 7 is connected to the battery 24, the trigger 25, the switch 26, the switching lever 27, the inverter circuit board 6, and the display section 26A as shown in FIG. 2. Further, the control section 7 includes a current detecting circuit 71, a switch-operation detecting circuit 72, an application-voltage setting circuit 73, a rotational-direction setting circuit 74, a rotor-position detecting circuit 75, a rotational-angle detecting circuit 76, an arithmetic section 78, a control-signal outputting circuit 79, a display circuit section 80 (display control unit), and an external connection terminal 81. The external connection terminal 81 is a terminal for connecting the PC 10 (FIG. 4), which is an external device, to the main body 1A. The external connection terminal 81 is provided at a bottom end portion of the handle section 22 opposing the battery 24 in top-bottom direction as shown in FIG. 1. The external connection terminal 81 serves as an external device connecting unit of the present invention. The PC 10 can be connected to the main body 1A only in a state where the battery 24 is detached from the main body 1A, so that settings of the electronic pulse driver 1 cannot be changed during a use thereof

The rotational-position detecting elements 8 are provided at positions opposing permanent magnets 3C of the rotor 3A in the axial direction of the output shaft section 31, and are arranged in a circumferential direction of the rotor 3A with a predetermined interval (for example, an angle of 60 degrees) therebetween.

Next, the configuration of drive control system of the motor 3 will be described while referring to FIG. 2. In the present embodiment, the motor 3 is a three-phase brushless DC motor. The permanent magnet 3C includes a plurality of sets (two sets in the present embodiment) of N pole and S pole. The stator 3B is three-phase stator windings U, V, and W in star connection.

A gate of each of the switching elements Q1-Q6 of the inverter circuit board 6 is connected to the control-signal outputting circuit 79 of the control section 7, and a drain or a source of each of the switching elements Q1-Q6 is connected to the stator windings U, V, and W of the stator 3B. The six switching elements Q1-Q6 performs switching operations based on switching-element driving signals inputted from the control-signal outputting circuit 79, and supplies to the stator windings U, V, and W the direct-current voltage of the battery 24 applied to the inverter circuit 6 as three-phase (U phase, V phase, and W phase) voltages Vu, Vv, Vw. Specifically, one of the stator windings U, V, and W to be energized, that is, the rotational direction of the rotor 3A is controlled based on output switching signals H1, H2, and H3 inputted to the positive side switching elements Q1, Q2, and Q3 from the control-signal outputting circuit 79. Further, an amount of supplying the stator windings U, V, and W with electric power, that is, the rotational speed of the rotor 3A is controlled based on pulse-width modulation signals (PWM signals) H4, H5, and H6 inputted to the negative side switching elements Q4, Q5, and Q6 from the control-signal outputting circuit 79.

The current detecting circuit 71 detects a value of current supplied to the motor 3 and outputs the detected value to the arithmetic section 78. The switch-operation detecting circuit 72 and the application voltage setting circuit 73 are electrically connected to the trigger 25. The switch-operation detecting circuit 72 detects whether the trigger 25 has been operated and outputs the detection result to the arithmetic section 78. The application-voltage setting circuit 73 outputs a signal based on an operation amount of the trigger 25 to the arithmetic section 78.

The rotational-direction setting circuit 74 is electrically connected to the switching lever 27. Upon detecting a switching operation of the switching lever 27, the rotational-direction setting circuit 74 outputs a signal for switching the rotational direction of the motor 3 to the arithmetic section 78.

The rotor-position detecting circuit 75 is electrically connected to the rotational-position detecting elements 8. The rotor-position detecting circuit 75 detects a rotational position of the rotor 3A based on signals from the rotational-position detecting elements 8, and outputs the detection result to the arithmetic section 78.

The rotational-angle detecting circuit 76 is for detecting an angle of the rotor 3 and for using the detected value when a control based on the rotations A based on a signal from the rotor-position detecting circuit 75 l angle is performed.

The arithmetic section 78 includes a central processing unit (CPU) (not shown) for outputting driving signals based on processing programs and data, an EEPROM 82 (storing unit) that is rewritable for storing data, and a timer (not shown). The CPU serves as a torque determining unit of the present invention. The EEPROM 82 stores the maximum value of tightening torque, the minimum value of tightening torque, the number of steps (division number), and a plurality of prescribed values that is obtained by equally dividing an interval between the maximum value and the minimum value by the number of steps. The number of steps is an integer value. Note that a minimum prescribed value of the prescribed values is the same as the minimum value, and that a maximum prescribed value of the prescribed values is the same as the maximum value. The above-mentioned maximum value, the minimum value, the number of steps, and the plurality of prescribed values are defined collectively as setting values. That is, the EEPROM 82 stores the maximum value of the tightening torque, the minimum value of the tightening torque, the number of steps, and the plurality of prescribed values as torque values calculated by dividing a torque range between the maximum value and the minimum value by the predetermined number. As will be described in greater detail, an operator can calculate the plurality of prescribed values by setting the maximum value and the minimum value each of the tightening torque and subsequently dividing the torque range into the number of steps. For example, assume that the maximum value of the torque is 5 Nm, the minimum value of the torque is 1 Nm, and the number of steps is 5. In this case, the torque range is 1 to 5, the predetermined number is 5, and hence the plurality of prescribed values (Nm) is 1, 2, 3, 4, and 5.

The arithmetic section 78 generates the output switching signals H1, H2, and H3 based on signals from the rotational-direction setting circuit 74 and the rotor-position detecting circuit 75, and generates the pulse-width modulation signals (PWM signals) H4, H5, and H6 based on signals from the application-voltage setting circuit 73, and outputs the generated signals to the control-signal outputting circuit 79. Note that the PWM signals may be outputted to the positive side switching elements Q1, Q2, and Q3, and the output switching signals may be outputted to the negative side switching elements Q4, Q5, and Q6.

The arithmetic section 78 is connected to the above-described switch 26. Based on an operation of the switch 26, one of the plurality of prescribed values stored in the EEPROM 82 is determined The arithmetic section 78 is connected to the display circuit section 80 receiving the signal therefrom. The display circuit section 80 is electrically connected to the display section 26A. The display circuit section 80 controls the display section 26A (the seven-segment display section 26B) based on the signal from the arithmetic section 78.

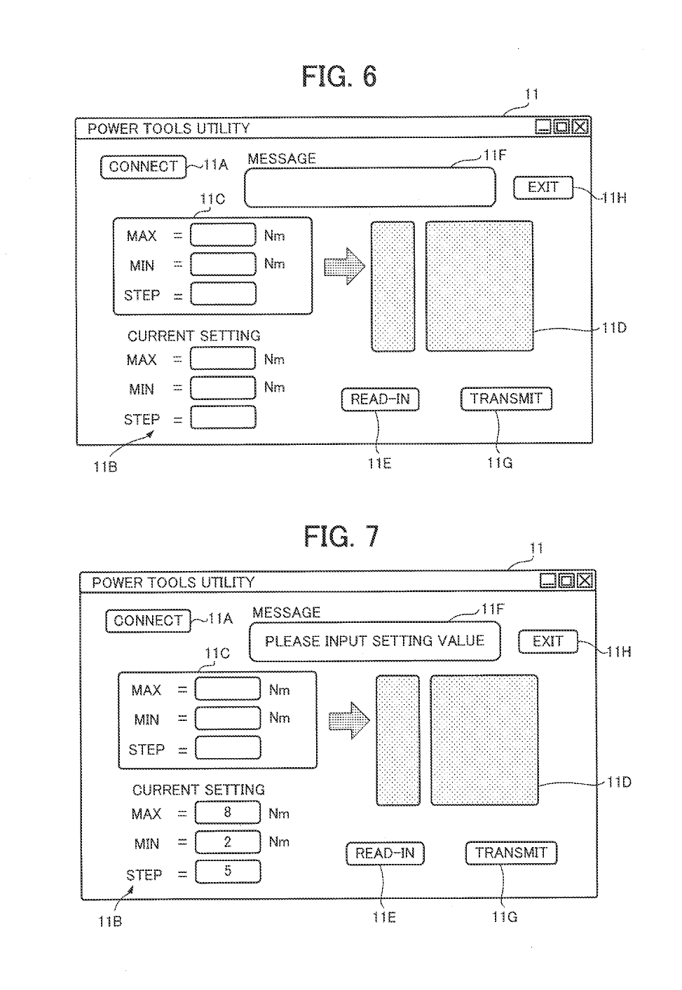

The PC 10 is a known personal computer and, as shown in FIG. 4, is connectable with the electronic pulse driver 1 via a cable 10A. As shown in FIG. 6, upon running an application software for controlling the electronic pulse driver 1, an operation-mode setting window 11 is displayed on a screen of the PC 10. The operation-mode setting window 11 may be automatically displayed on the screen in a state where the PC 10 is connected to the electronic pulse driver 1. The operation-mode setting window 11 serves as a changing unit of the present invention.

The operation-mode setting window 11 includes a connect button 11A, a set-value display area 11B, a setting-value input area 11C, a setting-value display area 11D, a read-in button 11E, a message display area 11F, a transmit button 11G, and an exit button 11H. The operation-mode setting window 11 is for setting the setting values such as the maximum value, the minimum value, and the number of steps, and for calculating the plurality of the prescribed values. The connect button 11A is clicked after the PC 10 is connected to the electronic pulse driver 1 via the cable 10A, and then the electronic pulse driver 1 is recognized on the PC 10. The set-value display area 11B displays setting values that are currently stored in the EEPROM 82 in the electronic pulse driver 1. The setting-value input area 11C is an area for inputting setting values that are newly rewritten. The setting-value display area 11D is an area for displaying step numbers and newly set setting values corresponding to the step numbers. The read-in button 11E is clicked after new setting values are inputted in the setting-value input area 11C, and then the inputted values are recognized as setting values. The message display area 11F displays a request to an operator or the like with respect to various conditions of the operation-mode setting window 11. When the transmit button 11G is clicked, values displayed in the setting-value display area 11D are transmitted to the electronic pulse driver 1 and then are stored in the EEPROM 82. When the exit button 11H is clicked, the operation-mode setting window 11 is closed and then the application software is ended.

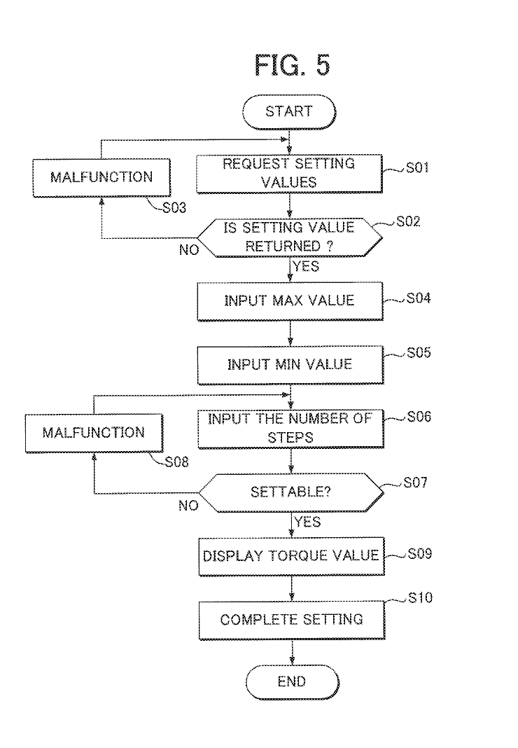

A process of setting an operation mode in the electronic pulse driver 1 and the PC 10 will be described while referring to the flowchart in FIG. 5 (selecting unit) and the operation-mode setting window 11. First, the process begins with S01 in a state where the electronic pulse driver 1 is connected to the PC 10. In S01, the connect button 11A is clicked to read in setting values stored in the EEPROM 82. If no setting value is returned from the electronic pulse driver 1 in S02 (S02: No), more specifically, if the electronic pulse driver 1 is not recognized within a predetermined time (within one sec), then the routine proceeds to S03. In S03, the PC 10 displays an error message such as “Check connection of the device” in the message display area 11F as a malfunction, and then returns to S01. If setting values are returned in S02 (S02: Yes), the PC 10 displays values read out from the EEPROM 82 in the set-value display area 11B and, as shown in FIG. 7, displays that “Please input setting value” in the message display area 11F while proceeding to S04.

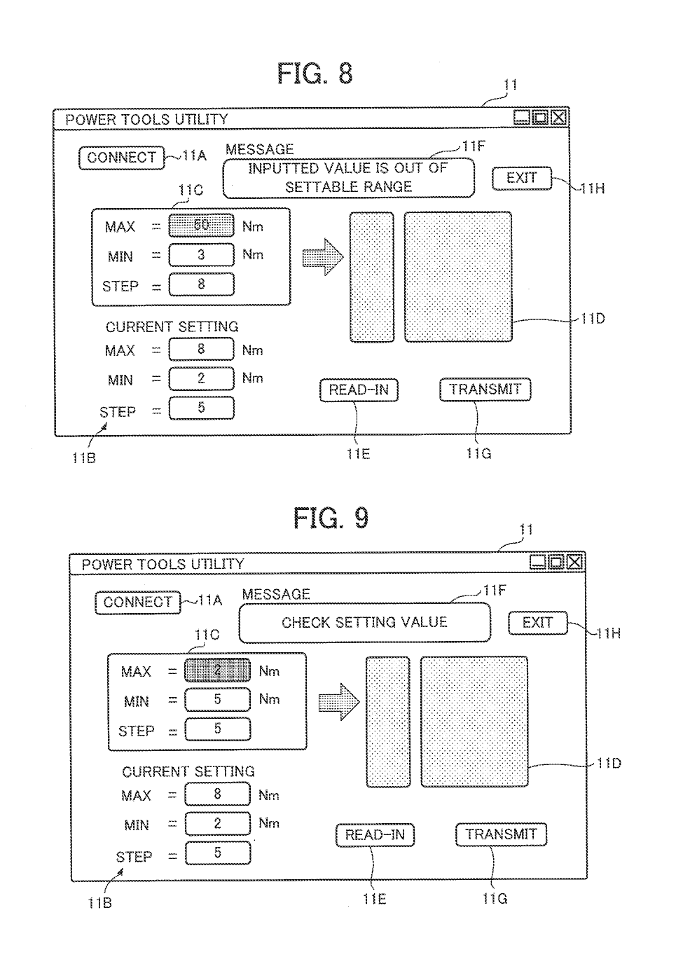

In S04, the operator inputs a maximum value in the setting-value input area 11C. Next, in S05, the operator inputs a minimum value in the setting-value input area 11C. Next, in S06, the operator inputs the number of steps for obtaining prescribed values in the setting-value input area 11C. The maximum value and the minimum value can be set between 10 to 1 Nm and be set at one decimal place. The number of steps is 10 steps at maximum. In S07, when the read-in button 11E is clicked, the PC 10 determines whether the setting values inputted in the setting-value input area 11C can be displayed in the setting-value display area 11D (that is, whether the setting values inputted in the setting-value input area 11C can be set). Specifically, if a maximum value larger than the settable maximum value, i.e., 10, is inputted as shown in FIG. 8, the PC 10 determines that the setting values cannot be displayed (set) (S07: No) and displays an error message such as “Inputted value is out of settable range” in the message display area 11F (S08). If a maximum value is smaller than a minimum value as shown in FIG. 9, the PC 10 determines that the setting values cannot be displayed (set) (S07: No) and displays an error message such as “Check setting value” in the message display area 11F (S08). If a number larger than a maximum number of steps, i.e., 10, is inputted, the PC 10 determines that the setting values cannot be displayed (set) (S07: No) and displays an error message “Inputted value is out of settable range” in the message display area 11F (S08). Then the routine returns to S06. Further, if the maximum value is the same as the minimum value and if a value other than “1” is inputted as the number of steps, then the PC 10 displays that “The number of steps cannot be changed in this case” in the message display area 11F, and a display of the number of steps is returned to “1”. Conversely, if the maximum value is different from the minimum value and if a value of “1” is inputted as the number of steps, then the PC 10 displays an error message such as “The setting value needs to be larger than or equal to 2” in the message display area 11F, and the inputted value of “1” is not reflected.

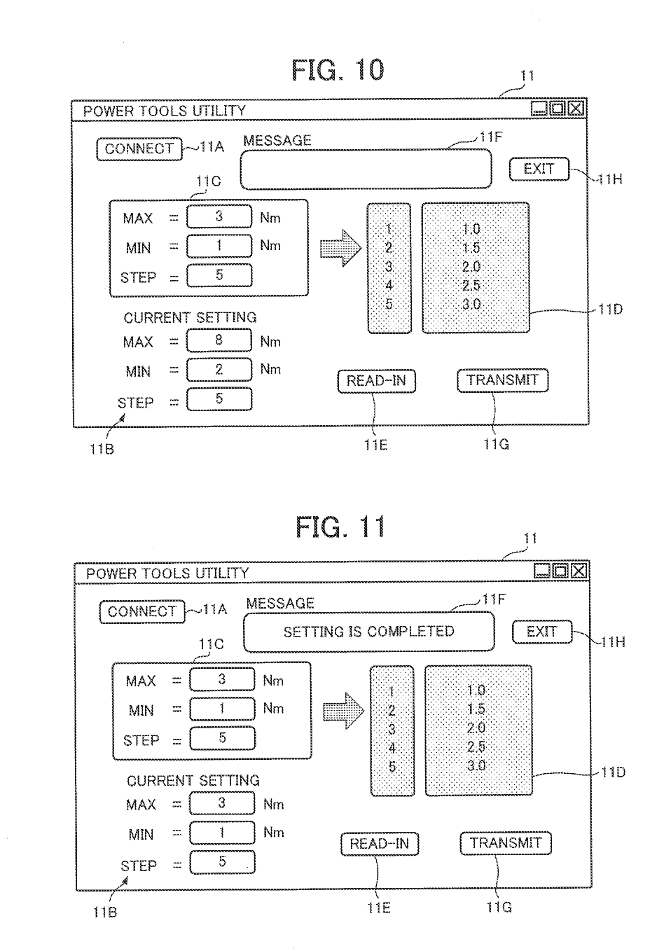

If it is determined that the values can be displayed (the values can be set) (S07: Yes), the routine proceeds to S09 and the PC 10 displays, in the setting-value display area 11D, the step number (1, 2, . . . , 5 in the present embodiment) and torque values (prescribe values) corresponding to each of the step number. In FIG. 10, the PC 10 displays in the setting-value display area 11D a maximum value of 3.0 Nm, a minimum value of 1.0 Nm, and torque values obtained by dividing by 5 the range between the minimum value and the maximum value. In S10, if the transmit button 11G is clicked, as shown in FIG. 11, the PC 10 transmits newly set setting values to the EEPROM 82 and then the setting values are stored in the EEPROM 82. The PC 10 also displays the setting values in the set-value display area 11B and displays that “Setting is completed” in the message display area 11F. Then, the process ends.

An operation of changing set torque values (a maximum value of 3.0 Nm, a minimum value of 1.0 Nm, the number of steps of 5) using the electronic pulse driver 1 will be described below. Note that, as shown in FIG. 11, torque values for the respective numbers of steps are allocated in five steps between 1.0 Nm and 3.0 Nm, such that the torque value is 1.0 Nm at the step number of 1 and that the torque value is 3.0 Nm at the step number of 5. At an initial state, the user operates the switch 26. When the switch 26 is pressed short once, the step number of 1 is displayed as shown in the left uppermost portion of FIG. 3B. When the switch 26 is pressed long in this state, the torque value of 1.0 Nm corresponding to the step number of 1 is displayed as shown in the right uppermost portion of FIG. 3B. Then, as shown in FIG. 2, the arithmetic section 78 receives the signal from the switch 26 upon the press thereof and outputs the signal to the display circuit section 80 to control the display section 26A to display a certain prescribed value.

Every time the switch 26 is pressed short, the step number increases by one, and can be changed from the minimum number of 1 to the maximum number of 5 as shown in the left side of FIG. 3B. The switch 26 is pressed long in a state where a certain step number is displayed, the torque value allocated based on each step number is displayed as shown in the right side of FIG. 3B. When a predetermined time (for example, 2 seconds) elapses after the torque value is displayed, a display is switched to the step number.

Accordingly, the operator presses the switch 26 short until a desired step number (torque value) is displayed. A desired setting value is displayed, and the setting value is stored in the EEPROM 82. As a method of storing the setting value, the setting value can be stored automatically if the switch 26 is not operated for a predetermined time or longer after the desired value is displayed, or the setting value can be stored by performing a predetermined operation with the switch 26. With the above-described operations, the operator can set a desired torque value. Note that, when the tightening operation is completed and the battery 24 is detached temporarily, and the like, the setting values may be reset, or the existing setting values may be retained.

With this configuration, because setting values can be changed, a wide range of tightening torque can be obtained with the electronic pulse driver 1. Further, because PC 10 is required to change the setting values and the like, inadvertent changes of the setting values and the like can be suppressed.

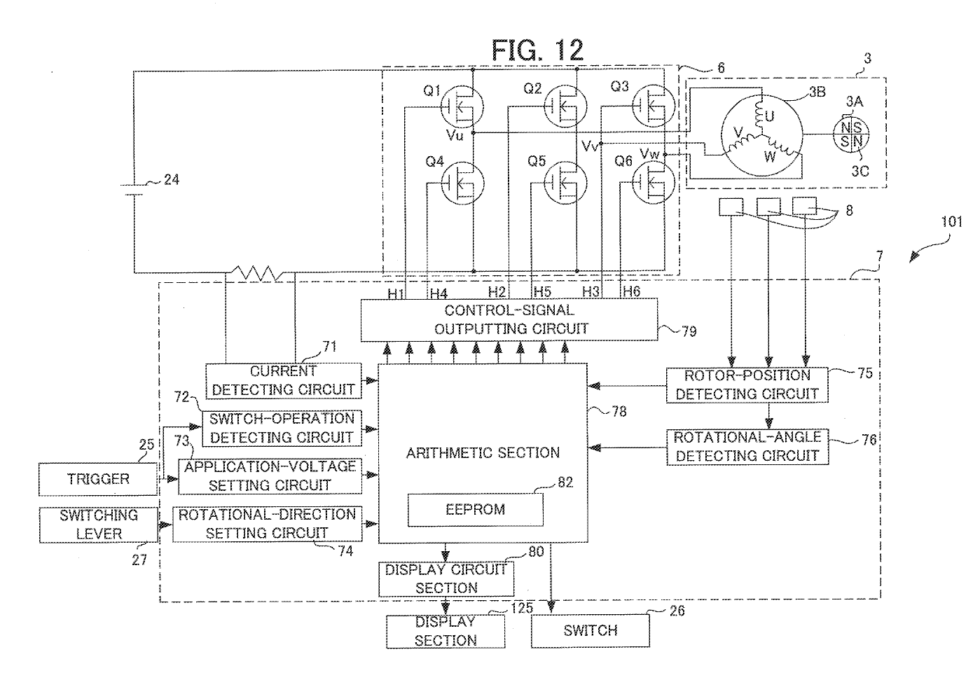

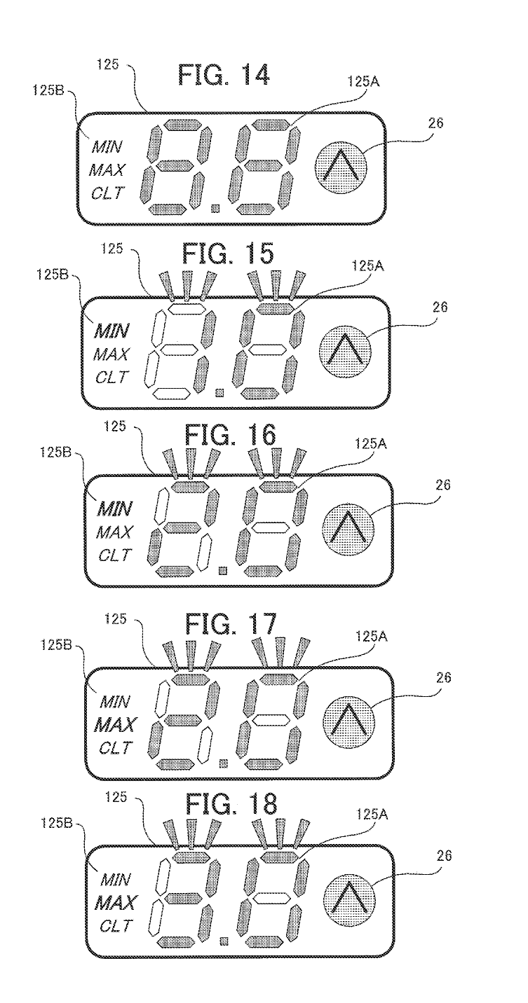

Next, a second embodiment of the invention will be described while referring to FIGS. 12 through 21. In the second embodiment, a power tool that can change an operation mode in a standalone manner without using an external device will be described. An electronic pulse driver 101 as the power tool according to the second embodiment is the same as the electronic pulse driver 1 according to the first embodiment, except that the power tool does not have an external connection terminal as shown in FIG. 12, and that the power tool has a different display section 125 as shown in FIGS. 14 and 21. Hence, duplicating descriptions will be omitted. Further, in the first embodiment, the switch 26 is used only for selection and determination of a prescribed value. In the second embodiment, however, the switch 26 is also used for changing setting values including a maximum value, a minimum value, and the number of steps. As shown in FIG. 14, the display section 125 includes two sets of seven-segment display section 125A and a lighting display section 125B having MIN, MAX, and CLT indications.

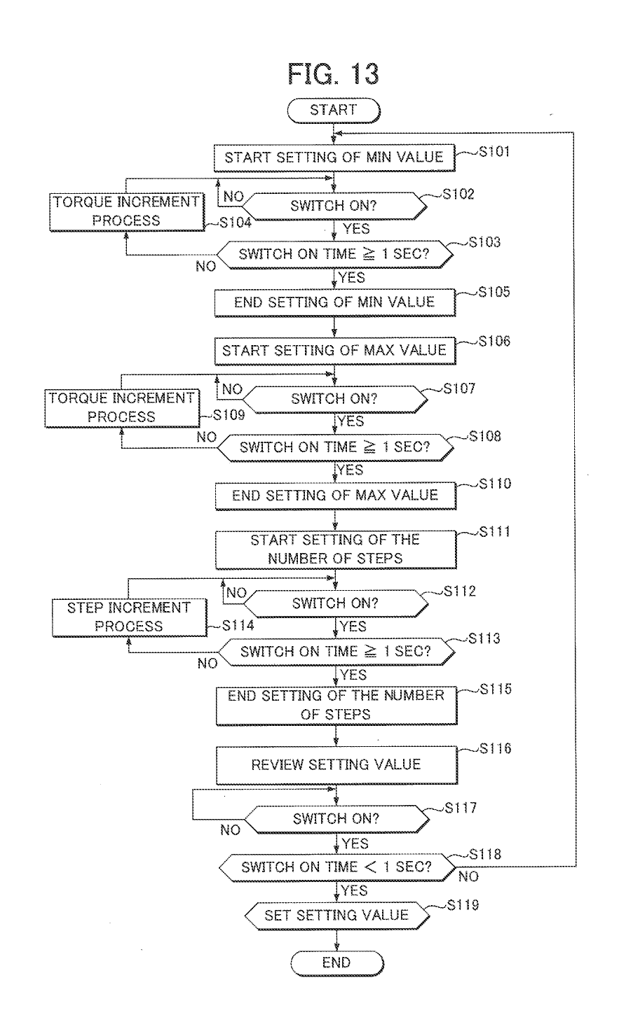

Steps of setting an operation mode with the electronic pulse driver 101 will be described while referring to the flowchart of the arithmetic section 78 in FIG. 13 and the display section 125. The electronic pulse driver 101 has a “setting mode” and a “manipulation mode”. First, at the beginning, the switch 26 is pressed long for a predetermined time or longer (for example, 3 seconds or longer), so that an operation mode of the switch 26 is switched from the manipulation mode to the setting mode. Then, the flowchart shown in FIG. 13 is started. Here, the “manipulation mode” is a mode of switching and determining a set plurality of prescribed values as described in the first embodiment, and the “setting mode” is a mode of changing the plurality of prescribed values (tightening torque). The “manipulation mode” serves as a first operation mode of the present invention, and the “setting mode” serves as a second operation mode of the present invention.

In this state, the CPU proceeds to S101, and first starts the setting of a minimum value. The above-described long press for 3 seconds or longer starts the setting mode and, at the same time, as shown in FIG. 15, “MIN” lights up in the lighting display section 125B and “1.0” blinks in the seven-segment display section 125A. The CPU determines whether the switch 26 is pressed in S102. If not (S102: No), then the CPU waits for a press of the switch 26. If so (S102: Yes), then the CPU determines whether the switch 26 has been pressed long for a period longer than or equal to 1 second and shorter than 3 seconds (S103). If the switch 26 is pressed short in this state in S102 (S103: No), then in S104 the indication of the seven-segment display section 125A increases by 0.1 Nm (torque increment process). Then the routine returns to S102. That is, each time the switch 26 is pressed short, the displayed value increases by 0.1 Nm. As shown in FIG. 16, after the indication of the seven-segment display section 125A reaches a predetermined minimum value, for example, 2.0 Nm, the operator presses long the switch 26 for the period. If it is determined that the switch 26 has been pressed long for the period (S103: Yes), the CPU temporarily stores the minimum value in the EEPROM 82 and ends setting of the minimum value (S105). That is, a torque value is changed with a short press of the switch 26, and the torque value is determined (set) with a long press.

Subsequently, the CPU proceeds to S106 and starts the setting of a maximum value. After the switch 26 is pressed long for 1 second or longer at the step of determining the minimum value (S103), as shown in FIG. 17, “MAX” lights up in the lighting display section 125B in a state where the minimum value is displayed, and the minimum value (for example, 2.0 Nm) displayed in the seven-segment display section 125A blinks. The CPU determines whether the switch 26 is pressed in S107. If not (S107: No), then the CPU waits for a press of the switch 26. If so (S107: Yes), then the CPU determines whether the switch 26 has been pressed long for the period longer than or equal to 1 second and shorter than 3 seconds (S108). If the switch 26 is pressed short in this state in S107 (S108: No), then in S109 the indication of the seven-segment display section 125A increases by 0.1 Nm (torque increment process) from 2.0 Nm which has been displayed as the minimum value. Then the routine returns to S107. That is, each time the switch 26 is pressed short, the displayed value increases by 0.1 Nm. After an indication of the seven-segment display section 125A reaches a predetermined maximum value (for example, 3.0 Nm) as shown in FIG. 18, the operator presses long the switch 26 for the period. If it is determined that the switch 26 has been pressed long for the period (S108: Yes), then in S110 the CPU temporarily stores the maximum value in the EEPROM 82 and ends setting of the maximum value. Here, because the maximum value is larger than the minimum value, an operation of setting the maximum value can be performed smoothly by displaying the minimum value in the seven-segment display section 125A as an initial value at the time of setting the maximum value.

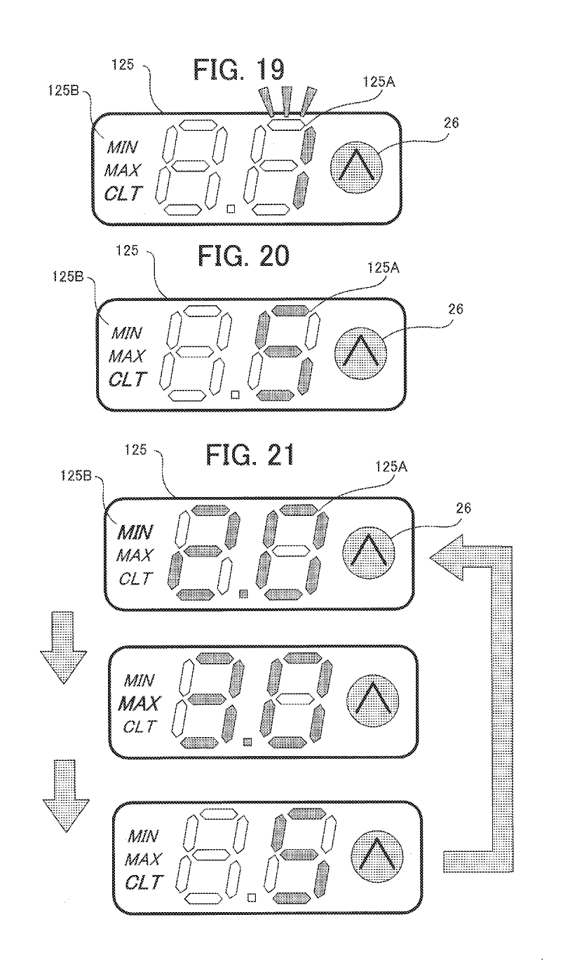

Subsequently, the CPU proceeds to S111 and starts the setting of the number of steps. After the switch 26 is pressed long for 1 second or longer at the step of determining the maximum value (S108), as shown in FIG. 19, “CLT” lights up in the lighting display section 125B, and “1” blinks in the seven-segment display section 125A. The CPU determines whether the switch 26 is pressed in S112. If not (S112: No), then the CPU waits for a press of the switch 26. If so (S112: Yes), then the CPU determines whether the switch 26 has been pressed long for the period longer than or equal to 1 second and shorter than 3 seconds (S113). If the switch 26 is pressed short in this state in S112 (S113: No), then in S114 the number of steps displayed in the seven-segment display section 125A increases by one (step increment process). Then the routine returns to S112. That is, each time the switch 26 is pressed short, the displayed step increases by one. After an indication of the seven-segment display section 125A reaches a predetermined number of steps (for example, 5) as shown in FIG. 20, the operator presses long the switch 26 for the period. If it is determined that the switch 26 has been pressed long for the period (S113: Yes), then in S115 the CPU temporarily stores the number of steps in the EEPROM 82 and ends setting of the number of steps.

Next, the CPU proceeds to S116 and performs a review of the setting values. After the switch 26 is pressed long for 1 second or longer at the step of determining the number of steps (S113), a setting-value review mode is started. Specifically, as shown in FIG. 21, “MIN”, “MAX”, and “CLT” light up repeatedly in this order at a predetermined time interval (for example, 0.5 second) in the lighting display section 125B, and the seven-segment display section 125A displays a setting value corresponding to an indication that lights up in the lighting display section 125B. In this state, the CPU proceeds to S117 and determines whether the switch 26 has been pressed. If so (S117: Yes), the CPU proceeds to S118. If not (S117: No), the CPU waits until the switch 26 is pressed. In S118, it is determined whether the switch 26 has been pressed long. If the switch 26 has been pressed for a period of shorter than 1 second (S118: Yes), the CPU proceeds to S119 and stores in the EEPROM 82 the minimum value (2.0 Nm), the maximum value (3.0 Nm), and the number of steps (5), and ends the setting mode. On the other hand, if the switch 26 has been pressed long for a period of longer than or equal to 1 second (S118: No), the CPU returns to S101 and redoes the settings. Note that, at the time when the number of steps is set in S115, each value may be fixed and end the setting mode. Anytime the switch 26 has been pressed 3 seconds or longer, the routine may be return to S101.

Because the setting range of tightening torque can be changed in both of the first embodiment and the second embodiment, a wide range of tightening torque can be dealt with by a single power tool. In particular, in the first embodiment, setting of an electronic pulse driver which is an example of a power tool is performed with a PC which is an example of an external device. Thus, an unintentional change of the setting values by an operator can be suppressed. Further, because an external device is not required in the second embodiment, the setting values can be changed easily and, when necessary, the setting values can be changed easily.

With this configuration, because a range of prescribed values affecting operations of the motor or the number of steps can be set arbitrarily, a wide range of operations can be performed with a single power tool. Further, prescribed values affecting operations of the motor can be changed on the power tool itself, facilitating changes of the prescribed values or the like.

With this configuration, because a maximum value, a minimum value and a plurality of prescribed values can be changed, a wide range of tightening torque can be obtained with a single power tool. Further, because the setting values and the like can be changed on the power tool itself, changes of the setting values and the like become easier.

While the power tool and the operation-mode change system of the power tool according to the invention have been described in detail with reference to the above aspects thereof, it would be apparent to those skilled in the art that various changes and modifications may be made therein without departing from the scope of the claims.

For example, in the second embodiment, because settings are performed only with the power tool, there is a possibility that settings cannot be performed well when the remaining amount of the battery is low. Thus, it may be so configured that a battery remaining-amount detecting circuit is provided in the control section for detecting the remaining amount of the battery, and that settings are prohibited based on a detection result of the battery remaining-amount detecting circuit

Further, in the above-described embodiment, a PC which is a general-purpose product is described as an example of an external device. However, the external device is not limited to a PC, but may be a special device for changing the operation mode and the setting values. Further, in the second embodiment, both of the manipulation mode and the change mode are implemented with the switch 26. However, the method is not limited to this, but a special operating section may be provided for each of the manipulation mode and the change mode.

Further, in the above-described embodiment, an electronic pulse driver is described as an example of a power tool. However, the power tool is not limited to this, but may be a tool that rotates an end bit with a motor, for example, a driver drill.

Further, the use is applicable for various works such as tightening of distribution boards, assembling of electronic appliances, assembling of automobiles, and the like.

Further, the power tool of the second embodiment may be configured to be connectable to an external device like the first embodiment. With this configuration, an operation mode can be changed with each of the power tool itself and the external device.

What is claimed is:

1. A power tool comprising:
a bit mounting unit configured to mount thereon a bit;
a motor configured to rotatingly drive the bit; and
a control unit configured to control a drive of the motor, the control unit including a storing unit configured to store a plurality of prescribed values affecting the drive of the motor and a division number by which a range of the plurality of prescribed values is divided,
wherein at least one of the range and the division number is arbitrarily settable.

2. The power tool according to claim 1, further comprising a setting unit configured to set an output condition of the motor,
wherein the range of the plurality of prescribed values is defined between a maximum value and a minimum value, the setting unit being configured to set at least one of the maximum value, the minimum value, and the division number.

3. A power tool system comprising:
a power tool according to claim 1, the power tool further comprising an external device connecting unit connected to the control unit; and
an external device connectable to the external device connecting unit,
wherein the range of the plurality of prescribed values is defined between a maximum value and a minimum value,
wherein the external device is configured to set at least one of the maximum value, the minimum value, and the division number.

4. A power tool comprising:
a bit mounting unit configured to mount thereon a bit;
a motor configured to rotatingly drive the bit mounting unit;
a control unit configured to control a drive of the motor, the control unit including a storing unit and a torque determining unit configured to determine the fastening torque, the storing unit being configured to store a plurality of prescribed values having a range for determining a fastening torque and a division number by which the range is divided;
a selecting unit configured to select one of the plurality of prescribed values, the torque determining unit determining the fastening torque based on the selection of the selecting unit; and
an external device connecting unit configured to be connected to an external device, the external device including a changing unit configured to change at least one of the range of the plurality of prescribed values and the division number.

5. The power tool according to claim 4, wherein the range of the plurality of prescribed value is defined between a maximum value and a minimum value, the changing unit being configured to change at least one of the maximum value, the minimum value, and the division number.

6. The power tool according to claim 4, further comprising a display unit configured to display a drive state of the motor, wherein the control unit includes a display control unit configured to control the display unit to display the drive state.

7. The power tool according to claim 4, wherein the external device includes a display for displaying an error indication when a value changed by the changing unit is an improper value.

8. The power tool according to claim 4, wherein the motor is a brushless motor.

9. A power tool comprising:
a bit mounting unit configured to mount thereon a bit;
a motor configured to rotatingly drive the bit mounting unit;
a control unit configured to control a drive of the motor, the control unit including a storing unit and a torque determining unit configured to determine a fastening torque, the storing unit being configured to store a plurality of prescribed values having a range for determining the fastening torque and a division number by which the range is divided; and
a selecting unit configured to select one of a first operation mode and a second operation mode, the selecting unit selecting one of the plurality of prescribed values in the first operation mode and the torque determining unit determining the fastening torque based on the selection of the selecting unit, the selecting unit changing at least one of the range of plurality of prescribed values and the division number in the second operation mode.

10. The power tool according to claim 9, wherein the range of the plurality of prescribed value is defined between a maximum value and a minimum value, the selecting unit being configured to change at least one of the maximum value, the minimum value, and the division number in the second operation mode.

11. The power tool according to claim 10, further comprising a display unit configured to display a drive state of the motor, wherein the control unit includes a display control unit configured to control the display unit to display the drive state.

12. The power tool according to claim 11, wherein the display control unit controls the display unit to display the maximum value, the minimum value, and the division number after the change of the selecting unit.

13. The power tool according to claim 9, wherein the motor is a brushless motor.

14. The power tool according to claim 9, further comprising a detachable battery configured to supply an electric power to the motor,
wherein the control unit includes a prohibition unit configured to prohibit the change of the selecting unit depending on a remaining amount of the battery.

15. A power tool system comprising:
a power tool comprising:
a bit mounting unit configured to mount thereon a bit;
a motor configured to rotatingly drive the bit mounting unit;
a control unit configured to control a drive of the motor, the control unit including a storing unit and a torque determining unit configured to determine a fastening torque, the storing unit being configured to store a plurality of prescribed values having a range for determining the fastening torque and a division number by which the range is divided;
a selecting unit configured to select one of the plurality of prescribed values, the torque determining unit determining the fastening torque based on the selection of the selecting unit; and
an external device connecting unit; and
an external device configured to connect to the external device connecting unit, the external device comprising a changing unit configured to change at least one of the range of the plurality of prescribed values and the division number.
